(19) United States
(12) Patent Application Publication
(10) Pub. No.: US 2012/0047012 A1
(43) Pub. Date: Feb. 23, 2012

(54) Targeted Publishing System Based on Profile Mashups

(76) Inventors: Palle M. Pedersen, Brookline, MA (US); Thomas C. Moran, Dennis, MA (US)

(21) Appl. No.: 13/214,155

(22) Filed: Aug. 19, 2011

Related U.S. Application Data
(60) Provisional application No. 61/375,799, filed on Aug. 21, 2010.

(51) Int. Cl. G06F 17/30; G06Q 30/00

(52) U.S. Cl. 705/14.49; 707/756; 707/E17.009

(57) ABSTRACT

A targeted publishing system based on profile mashups improves on traditional methods for identifying and delivering targeted content to specific end users by using data from sources related to one or more addresses (including physical addresses) for the end user in order to understand more clearly what targeted content to deliver to such specific end user.

### CROSS-REFERENCE TO RELATED APPLICATIONS

This utility patent application claims priority from U.S. provisional patent application Ser. No. 61/375,799, filed 21-Aug.-2010, titled “TARGETED PUBLISHING SYSTEM BASED ON PROFILE MASHUPS” in the name of Palle M. Pedersen and Thomas C. Moran, which is hereby fully incorporated by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2011, Palle M. Pedersen and Thomas C. Moran.

### TECHNICAL FIELD

This invention relates to digital publishing systems, personalized content and targeted advertisements.

### BACKGROUND

The move from traditional media to digital media has enabled the delivery of content to end users on a one-to-one basis, where each end user receives content specifically for them, instead of the traditional one-to-many basis (example: printing and physical distribution of magazine, newspaper and other periodicals) where exactly the same content is delivered to all end users.

One use of such one-to-one delivery is the delivery of personalized content, which is content selected for particular end users, based on criteria such as demographics, expressed interests, and observed likes and dislikes. Personalized content spans a wide range of applications, from Amazon's “Customers Who Bought This Item Also Bought” feature, where customers can see products related to the product they are currently viewing, to Mine magazine by Time, which was a magazine in digital or print form containing articles chosen according to each end users stated interests.

In a very similar way, targeted advertisements are advertisements selected in an attempt to reach the most relevant end users, based on criteria such as demographics and purchasing behavior.

Current state-of-the-art systems for delivering targeted advertisements fall into three groups, location-based targeting, where the advertisement selection is done based on the current location of a mobile device on which the advertisement is shown, behavioral targeting, where the advertisement selection is done based on previous user behavior (example: the original behavior of Doubleclick), and contextual targeting, where the advertisement selection is done based on the surrounding content (example: Google AdSense), search terms used to find the content (example: Google search pages) along with other context in which the advertisement appears.

### BRIEF SUMMARY OF THE INVENTION

A targeted publishing system based on profile mashups improves on traditional methods for identifying and delivering targeted content to specific end users by using data from sources related to one or more addresses (including physical addresses) for the end user in order to understand more clearly what targeted content to deliver to such specific end user.

### BRIEF DESCRIPTION OF THE DRAWINGS

FIG. 1 is a system diagram of an example of an implementation of a targeted publishing system based on profile mashups.

FIG. 2 is a flowchart illustrating an example of an implementation compiling a profile mashup for an end user.

FIG. 3 is a flowchart illustrating an example of an implementation creating a targeted content placement for a piece of targeted content.

FIG. 4 is a flowchart illustrating an example of an implementation creating assembled content for delivery to a specific end user.

FIG. 5-1, FIG. 5-2, FIG. 5-3, FIG. 5-4, and FIG. 5-5 are tables of examples of implementations for combinations of the assembly and analysis of end user data centered around a physical end user address for the purposes of ad targeting.

### DETAILED DESCRIPTION OF THE INVENTION, INCLUDING THE PREFERRED EMBODIMENT

In the following detailed description of the invention, reference is made to the accompanying drawings which form a part hereof, and in which are shown, by way of illustration, specific embodiments in which the invention may be practiced. It is to be understood that other embodiments may be used, and structural changes may be made without departing from the scope of the present invention.

### INTRODUCTION

Personalized content and targeted advertisements are very similar in the way that they attempt to match up the content (incl. advertisements) based on the relevance of the content to the end user, and for the purposes of this document, both personalized content and targeted advertisements will be referred to as targeted content.

The traditional approaches to the delivery of targeted content are based on a notion that information about the receivers and end users of digital content should be derived from observable actions (e.g. their actions and selections), from user supplied information (e.g. web-site or survey-based profiles), or from combinations of the two. Such end user information will be referred to as collected profiles.

However, there are many situations where either the actual end user's identity with name and address or simply the address of the end user is known. Typically such situations are where the end user has a shipping address or billing address on file with a content publisher. These situations include shopping sites and mail order merchants used by the end user as well as publications (e.g. news-papers, magazines, trade journals, catalogues) subscribed to by the end user.

### Operation

A targeted publishing system based on profile mashups improves on traditional methods for identifying and delivering targeted content to specific end users by using data from sources related to one or more addresses (including physical addresses) for the end user in order to understand more clearly what targeted content to deliver to such specific end user.

When content is delivered to an end user from a targeted publishing system based on profile mashups, each end user is identified using a unique end user identifier (e.g. a publication subscriber ID, email address, web-site login, account number, security certificate, assigned UUID, unique cookie, mobile phone number, or other unique identifier). Using this unique end user identifier, the end user is associated with one or more end user addresses, which are postal addresses, physical addresses, or other means of identifying the location of a building. An end user address can be determined in a variety of ways. If the end user is a subscriber to a printed publication (e.g. a printed news-paper, magazine, trade journal, or catalogue) then an end user address can be a physical delivery address of this publication as well as a billing address for the subscriber's account on file. If the end user is a subscriber to an electronic publication (e.g. an online news-paper, magazine, blog, web-site, trade journal, or catalogue) then an end user address can be an address associated with the subscriber profile or a billing address for the subscribers account on file. If the relationship with the end user has been established by a purchase of products or services, an end user address can be the shipping address or the billing address used for the purchase. Other ways to establish an end user address include matching up the end user information with external databases (e.g. phone books, employer addresses, or databases with email addresses and physical addresses).

The end user addresses are used to find further information from a variety of other end user data sources where an end user address can be used to find data related to the end users. These other end user data sources can include public and private information for the specific end user address (e.g. property assessment records, excise or other tax records, RMV records, driving records, permits, credit agency data, customer lists, warranty lists, travel history, airline mileage program history, loyalty club records, employment information, court records, and purchase histories) as well as aggregated information for the area (e.g. school district information, local area news, police/fire logs, demographics, and census data).

A profile mashup for an end user is created by first selecting data from relevant other end user data sources based on the end user addresses for the end user and optionally adding data from a collected profile. The selection of data from relevant other end user data sources can be based on an end user address in a variety of ways, used alone or in combination, including an approximate match on names, an approximate match on addresses, an approximately match on normalized addresses, an approximate match on the geo-location of addresses. In addition, the selection of data from relevant other end user data source can be based an end user address due to second order or higher order relationships, where data in one relevant end user data source (examples: phone number, identity of spouse, parents, kids, registration numbers) can used to find data in another end user data source. This data is then organized and processed into a set of profile mashup criteria in order to create the final profile mashup. The profile mashup criteria are the criteria used to select the targeted content for the related end user and can be as simple as the data directly present in the other end user data sources (e.g. profile mashup criteria: “Brand of car” with values “BMW”, “Mercedes”, “Ford”, etc.) or a more complex derivation of the data (e.g. profile mashup criteria: “Potential of buying high end car for young person” with values ranging from “100%” to “0%” based on number of kids at address between 16 and 18 years old and the purchase price of current cars, etc.). The profile mashup criteria in use may contain the formulas for computing the values and may be specified explicitly or may be derived from manual or automatic search or data-mining of the data available.

Targeted content and the related information is managed by a targeted content management user, who is the person (or persons) in charge specifying the targeted content as well as where the targeted content is going to appear. A targeted content management user can analyze the potentially targeted end users using profile mashup examination queries, which are normal query, search, and data-mining techniques used to examine the profile mashups. The examination techniques include examining existing profile mashup criteria (e.g. “Brand of car” is “BMW”, “Mercedes”, or “Audi”), examining any values in the profile mashups (e.g. “BMW” is in any profile mashup criteria), process these results using conditional, computational or text processing formulas (e.g. “Property assessed value”/$1MM+“Car purchase price”/$100 k), refinements and recursive application of formulas, etc.

When a targeted content management user has found a profile mashup examination query with a result set that can be used to identify an appropriate set of end users, the profile mashup examination query can either be used directly in the creation of targeted content placements, which specify the profile mashup examination query that is used to determine which end users to deliver the corresponding targeted content to, or be used to create a new profile mashup criteria with all the resulting data filled in appropriately.

Each piece of targeted content is associated with one or more targeted content placements. Additionally, the targeted content placements specify a target location, which specifies the associated location in the assembled content as well as a target priority which is used to determine which targeted content is to be delivered to an end user when multiple pieces of targeted content fit a particular end user. In the case where the data from all profile mashups are available at the time of the targeted content placement creation, it is possible to determine the exact number of end users to whom the targeted content will be made available, and this number can be used during the targeting decision process.

The target location can be specified in a variety of ways, from being a very specific location (e.g. 1/2 page advertisement on page 4 in the final document, video introduction before content labeled “Editorial Comment”, or replacement of the section tagged with “customized story #1”) to being more unspecific (e.g. any ¼ page advertisement or right after any article which includes the term “luxury car”). When appropriate, the target location can use mechanisms and formats already in use for specifying content and location of content in the publishing systems.

The general content contains the content intended for delivery to all end users as well as targeted content locations with information about where targeted content fits in. The targeted content locations can be indicated in a variety of methods, ranging from tags and meta data embedded in the general content to the inclusion of sample or default pieces of content which is to be replaced with targeted content. In either case, the general content is managed by a general content management user who in many cases would do this using a traditional content management system (e.g. Documentum, Adobe Dreamweaver, Adobe In Design, Quark Xpress, etc.).

Assembled content, which is the final content delivered to end users, is created by combining the general content with the targeted content, using the targeted content placements. The targeted content is selected for each end user based on the targeted content placements, including the target priority. In addition, other criteria traditionally used in targeted advertisements or personalized content can be added to the selection criteria.

The creation and delivery of the assembled content to the end user can be done in a variety of ways and at various points of time, often using existing infrastructure. Assembled content can be created where it fits within the publishing process, including when an end user requests the assembled content, on a specific schedule, when the publisher decides to publish the content to the end user, etc. Assembled content can be delivery to end users in a variety of ways, including via computer networks (examples: TCP/IP network, LAN, WAN, broadband, wireless, satellite) and through web-sites, apps from app-stores (examples: iTunes AppStore, Android Market), book, document and magazine readers (examples: Adobe Reader, iBook, iPad, Kindle, Nook, Zinio, Zmags), multi-media outlets (examples: iTunes, YouTube), etc. Assembled content can also be delivery to a variety of devices, including hand-held devices (examples: smart-phone, Kindle, Nook, iPad), multi-media players (examples: MP3 player, video player), and general purpose computing devices (examples: laptop, desktop, netbook), etc.

Note that one of the benefits of this approach is that a specific physical device (e.g. user terminal, set top box, hand held device, etc.) or a specific network operator (e.g. cell phone carrier, phone company, cable operator, data service provider, etc.) is not needed to identify the end user and the end user address. In other words, content can be targeted without the cooperation of the network operator or the device manufacturer, device merchant, and/or device service provider.

### Example System

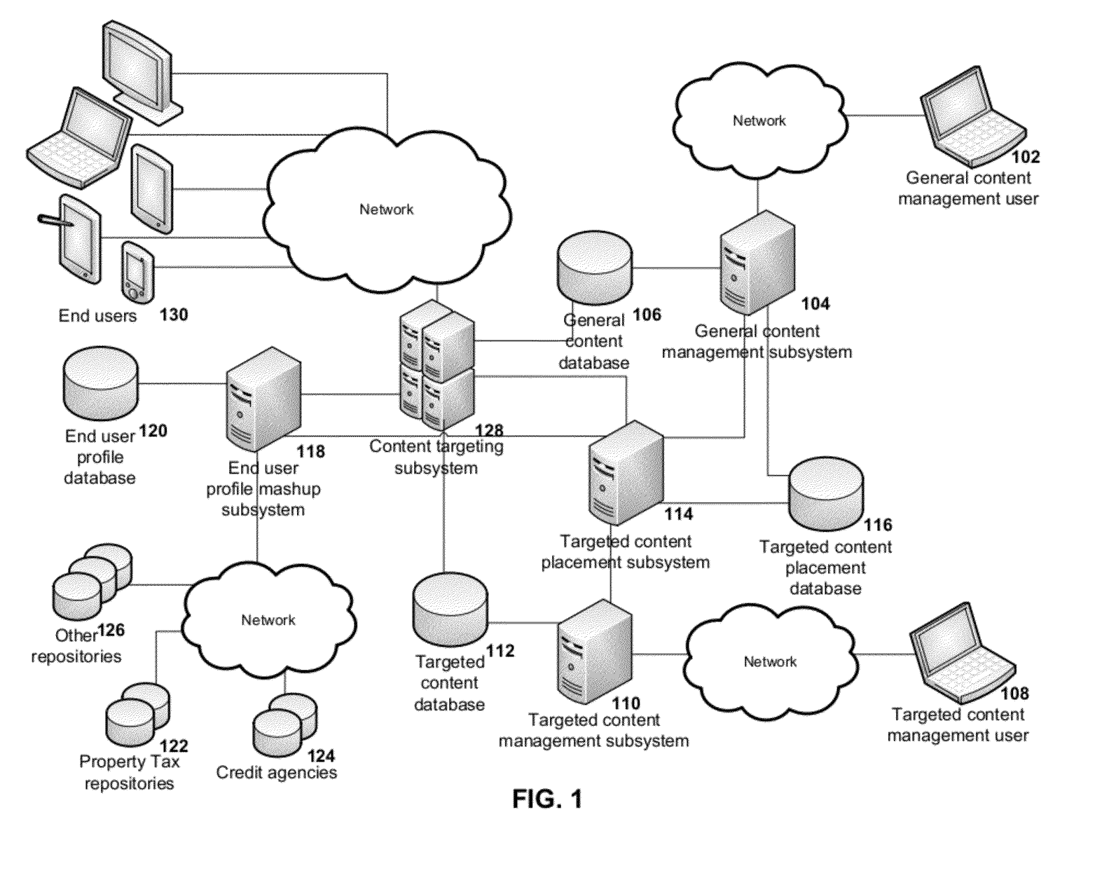

FIG. 1 illustrates an example of an implementation of a targeted publishing system based on profile mashups. In this implementation, the general content management subsystem (104) is used by the general content management user (102) to create, edit, and delete general content in the general content database (106) as well as to deliver reports on how the general content has been used.

The targeted content management subsystem (110) is used by the targeted content management user (108) to create, edit, and delete targeted content in the targeted content database (112) as well as to deliver reports on how the targeted content has been used. The targeted content management subsystem is also used in conjunction with the targeted content placement subsystem (114) to create, edit and delete related targeted content placements stored in the targeted content placement database (116).

The end user profile mashup subsystem (118) compiles the profile mashups of end users by combining the end user information from the end user profile database (120) with data from other end user data sources, e.g. Property Tax Repositories (122), Credit Agencies (124), and Other Repositories (126). The end user profile database is typically compiled from databases of end users used by the operators of the targeting system (examples: magazine subscriber lists, customer lists with shipping and/or billing addresses, etc.). The end user profile mashup subsystem (118) may save some or all this other end user data in the end user profile database (120), but independent of what it saves, it delivers the profile mashup for a specific end user when requested by the content targeting subsystem (128).

The content targeting subsystem (128) receives requests from specific identifiable end users (130) for content, and uses the related general content from the general content database (106) with the information from the profile mashup for the specific end user delivered by the end user profile mashup subsystem (120) in order to access the targeted content placement subsystem (114) which identifies the portions of the targeted content in the targeted content database (112) to retrieve and assemble into assembled content. The assembled content is then delivered by the content targeting subsystem (128) to the end user and the end user's specific device.

### Example of Compiling a Profile Mashup

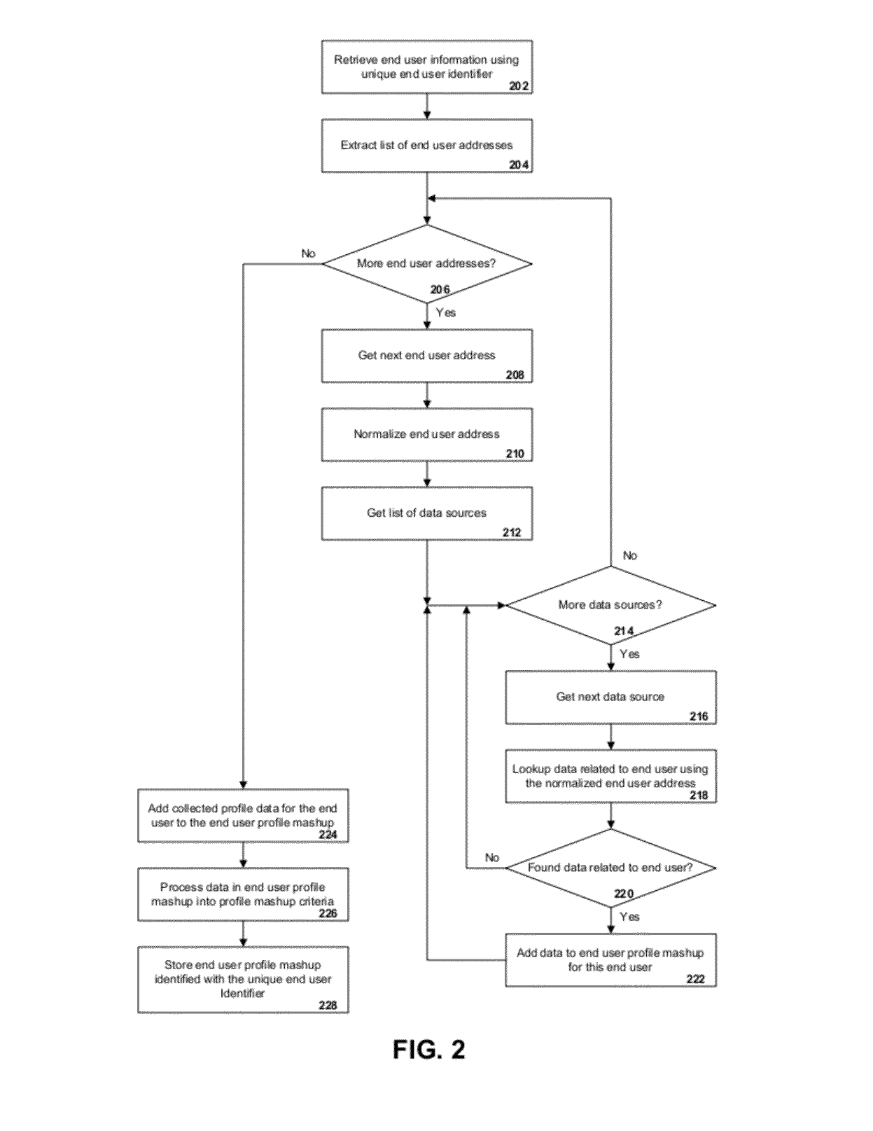

FIG. 2 shows an example of an implementation compiling a profile mashup for an end user. In this example, end user information is first retrieved (Step 202) using a unique end user identifier, after which the list of end user addresses associated with this end user is extracted (Step 204). The end user information could be as simple as an end user address or it could contain a more complex set of information to supplement the end user address.

For each end user address associated with this end user, the end user address is normalized (Steps 206, 208, 210) into a form which makes it easier to look up data in the other end user data sources. The other end user data sources are now examined one by one (Steps 212, 214, 216) by doing a look up using the normalized end user address (Step 218). If any data that relates to the end user is found in the data source (Step 220), this data is added to the end user profile mashup (Step 222).

When all the other end user data sources have been examined using all the end user addresses, the collected profile data is added (Step 224), all data is processed according to the end user profile criteria (Step 226), and the final end user profile mashup is stored along with the unique end user identifier (Step 228) for further reference.

In the implementation of FIG. 1, the content targeting subsystem (128) retrieves end user information (Step 202) using a unique end user identifier provided by the end user or end user's device (130), after which the list of end user addresses associated with this end user is extracted (Step 204) from the end user profile database (120), which may in turn have been derived from publication subscriber lists, customer lists or other lists with shipping, billing or other addresses, etc. The end user information could be as simple as an end user address or it could contain a more complex set of information to supplement the end user address.

For each end user address associated with this end user, the end user address is normalized (Steps 206, 208, 210) into a form which makes it easier to look up data in the other end user data sources (122, 124, 126). The end user profile mashup subsystem (118) now examines the other end user data sources one by one (Steps 212, 214, 216) by doing a look up using the normalized end user address (Step 218). If any data that relates to the end user is found in the data source (Step 220), the end user profile mashup subsystem data adds this data to the end user profile mashup (Step 222).

When the end user profile mashup subsystem (118) have examined all the other end user data sources (122, 124, 126) using all the end user addresses from the end user profile database (120), the subsystem adds the collected profile data (Step 224) from the end user profile database (120), and process all the data according to the end user profile criteria (Step 226), also found in the end user profile database (120), and the final end user profile mashup is stored in the end user profile database (120) along with the unique end user identifier (Step 228) for further reference. Other hardware implementations are possible.

### Example of Targeting Content

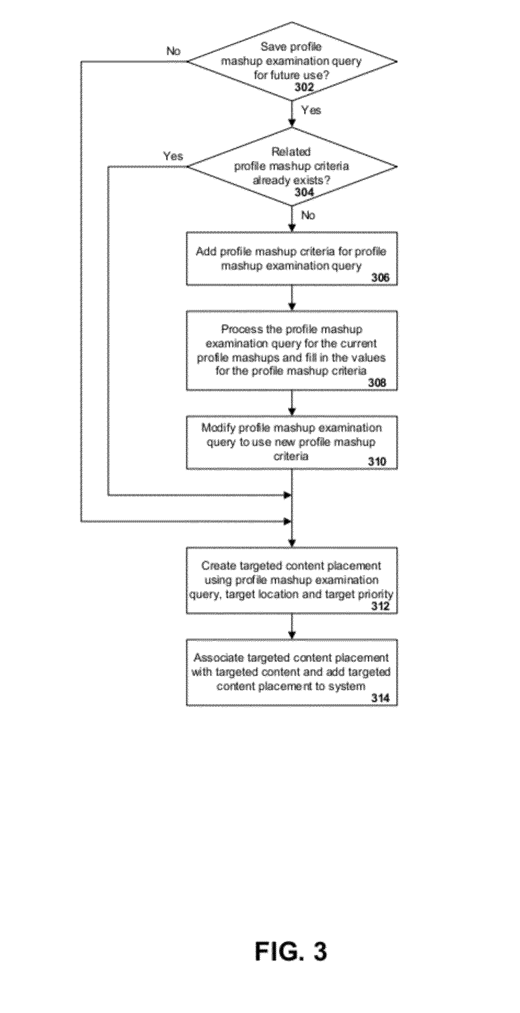

FIG. 3 shows an example of an implementation creating a targeted content placement for a piece of targeted content. In this example, a profile mashup examination query, a target location, and a target priority for a piece of targeted content are supplied by a targeted content management user. If there is a request for saving the profile mashup examination query as a profile mashup criteria (Step 302) and if no profile mashup criteria for the profile mashup examination query is found (Step 304), a new profile mashup criteria which includes the profile mashup examination query is added (Step 306). The values for these new profile mashup criteria are then filled in for all the profile mashups (Step 308), and a new profile mashup examination query using these profile mashup criteria will be used instead of the original profile mashup examination query in the following processing (Step 310).

Using the profile mashup examination query which was either found or newly created along with the target location and target priority, a targeted content placement is created (Step 312). This targeted content placement and its association with the targeted content are then added to system (Step 314).

In the implementation of FIG. 1, a profile mashup examination query, a target location, and a target priority for a piece of targeted content are supplied by a targeted content management user (108) to the targeted content management placement subsystem (114) through the target management subsystem (110). If the targeted content management user request to save the profile mashup examination query as a profile mashup criteria (Step 302), then the end user profile mashup subsystem (118) checks if a profile mashup criteria for the profile mashup examination query already exists in the end user profile database (120) (Step 304), and if it does not exist, a new profile mashup criteria which includes the profile mashup examination query is added to the end user profile database (Step 306). The values for these new profile mashup criteria are then filled in for all the profile mashups (Step 308) and the values stored in the end user profile database (120) by the end user profile mashup subsystem (118), and a new profile mashup examination query using these profile mashup criteria will be used instead of the original profile mashup examination query in the following processing (Step 310).

Using the profile mashup examination query which was either found or newly created along with the target location and target priority, a targeted content placement is created (Step 312) by the targeted content placement subsystem (114). This targeted content placement and its association with the targeted content are then added to the targeted content placement database (116) (Step 314).

Other hardware implementations are possible.

### Example of Assembling Content

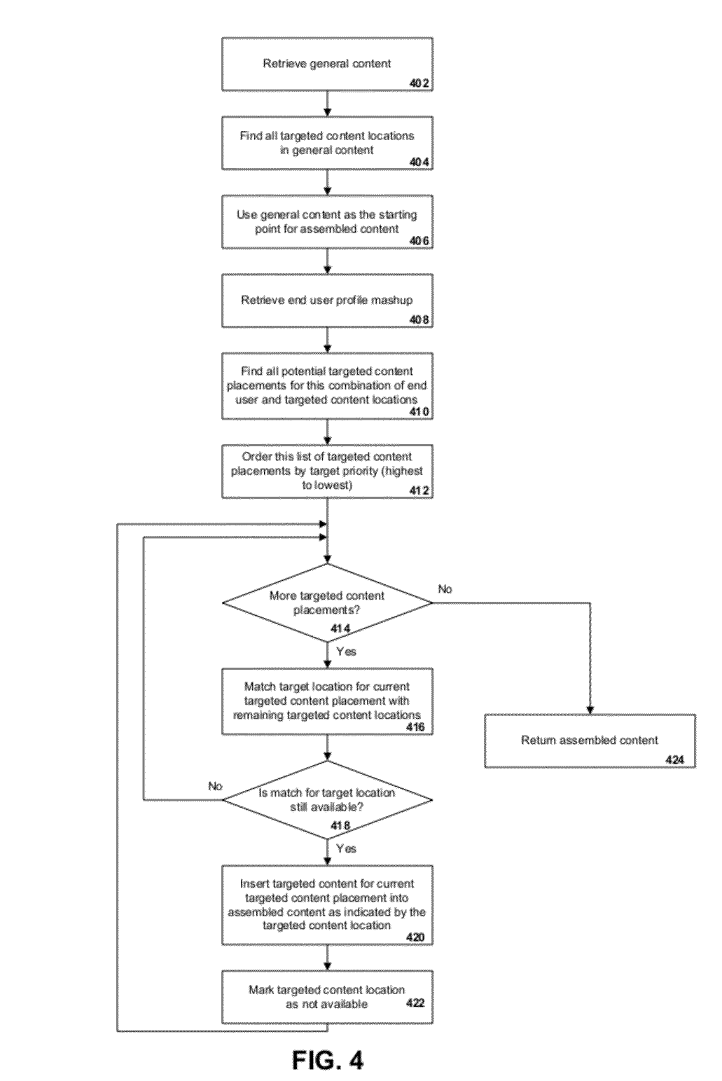

FIG. 4 shows an example of an implementation creating assembled content for delivery to a specific end user. In this example, the general content is first retrieved (Step 402) after which all targeted content locations in the general content are found (Step 404). All entries in this list of targeted content locations are initially unmarked, and thus available. This general content is also used as the starting point for the assembled content (Step 406), which is used to combine the targeted content with the general content.

The end user profile mashup is then retrieved for the end user whom the assembled content is being assembled for (Step 408). This retrieval could, by example, be done as illustrated in FIG. 2. Using this end user profile mashup and the list of targeted content locations, all potential targeted content placements for this end user and general content combination are found (Step 410) and the list of targeted content placements is ordered by target priority (Step 412).

This ordered list of targeted content placements is now processed one by one and, while there are still targeted content placements left to process (Step 414), check the target location for this target against the remaining entries in the list of targeted content locations which has not been marked not available (Step 416).

If no corresponding targeted content location is available, then skip this target content placement (Step 418), otherwise insert the targeted content for this target content placement into the assembled content as indicated by the targeted content location (Step 420) and mark this targeted content location as not available (Step 422), since it has been filled with targeted content for this target content placement.

When there are no more targeted content placements to process for the assembled content, return the assembled content to the application or directly to the end user (Step 424).

In the implementation of FIG. 1, after one of the end users (130) request content from the content targeting subsystem (128), the general content is retrieved (Step 402) from the general content database (106) by the content targeting subsystem, after which all targeted content locations in the general content are found (Step 404) by the targeted content placement subsystem (114) from the targeted content placement database (116). All entries in this list of targeted content locations are initially unmarked, and thus available. This general content is also used by the content targeting subsystem (128) as the starting point for the assembled content (Step 406), which is used to combine the targeted content stored in the targeted content database (112) with the general content stored in the general content database (106).

Using a unique end user identifier supplied by the end user (130) in connection with the request for content from the content targeting subsystem (128), the content targeting subsystem retrieves the end user profile mashup from the end user profile mashup subsystem (118) (Step 408). This retrieval could, by example, be done as illustrated in FIG. 2. The content targeting subsystem (128) use this end user profile mashup retrieved from the end user profile mashup subsystem (118) and the list of targeted content locations retrieved from the targeted content placement subsystem (114) to find all potential targeted content placements for this end user and general content combination (Step 410) and the list of potential targeted content placements is ordered by the target priority (Step 412).

This ordered list of targeted content placements is now processed one by one by the content targeting subsystem (128), and while there are still targeted content placements left to process (Step 414) check the target location for this target against the remaining entries in the list of targeted content locations which has not been marked not available (Step 416).

If no corresponding targeted content location is available, then the content targeting subsystem (128) skip this target content placement (Step 418), otherwise content targeting subsystem insert the targeted content from targeted content database (112) for this target content placement into the assembled content as indicated by the targeted content location (Step 420) and mark this targeted content location as not available (Step 422), since it has been filled with targeted content for this target content placement.

When there are no more targeted content placements to process for the assembled content, the content targeting subsystem (128) return the assembled content to the end user (130) who originally requested the content (Step 424).

Other hardware implementations are possible.

### Examples of Targeting Using Specific Data

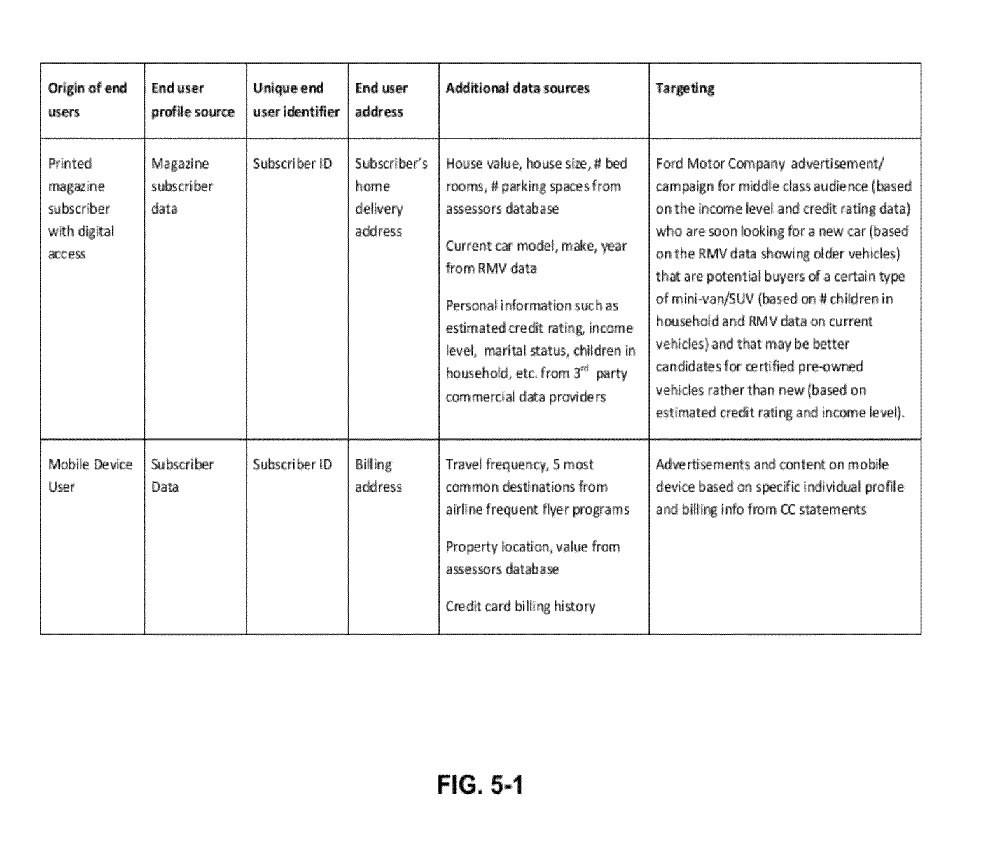

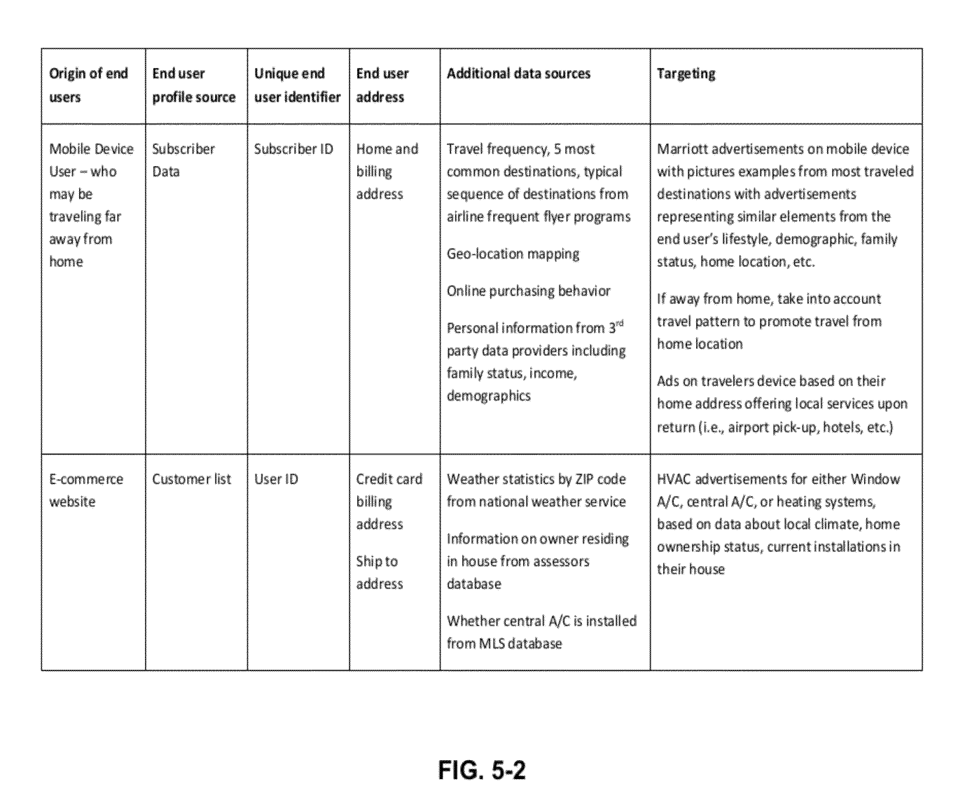

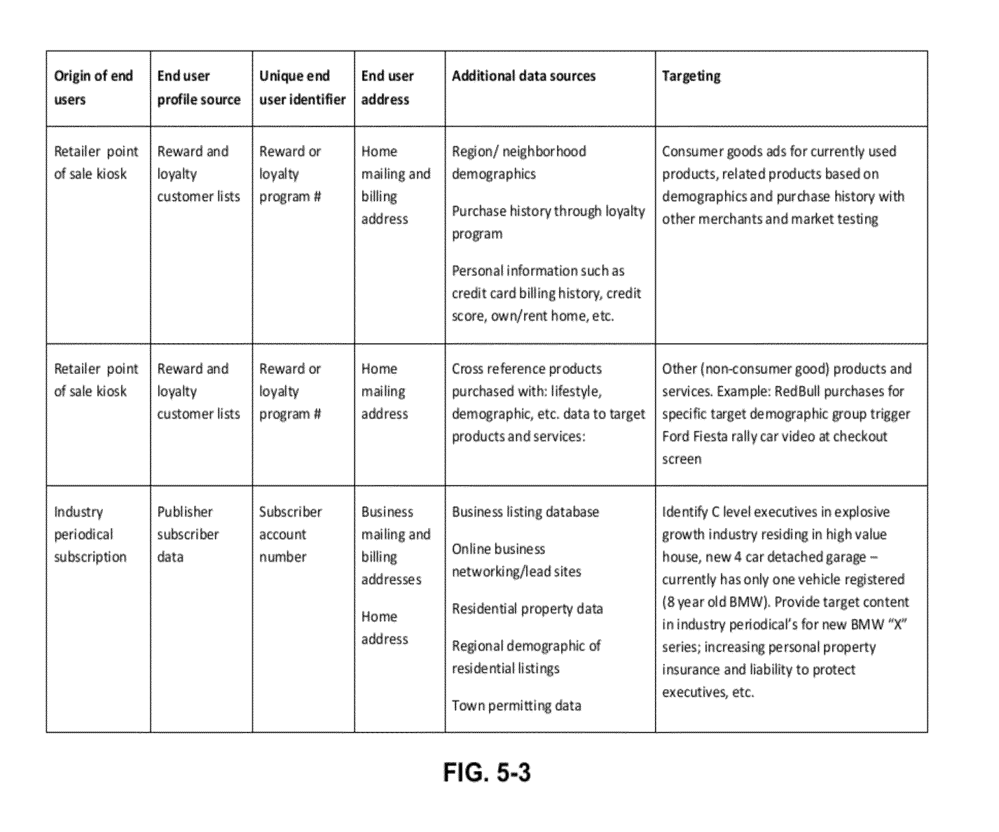

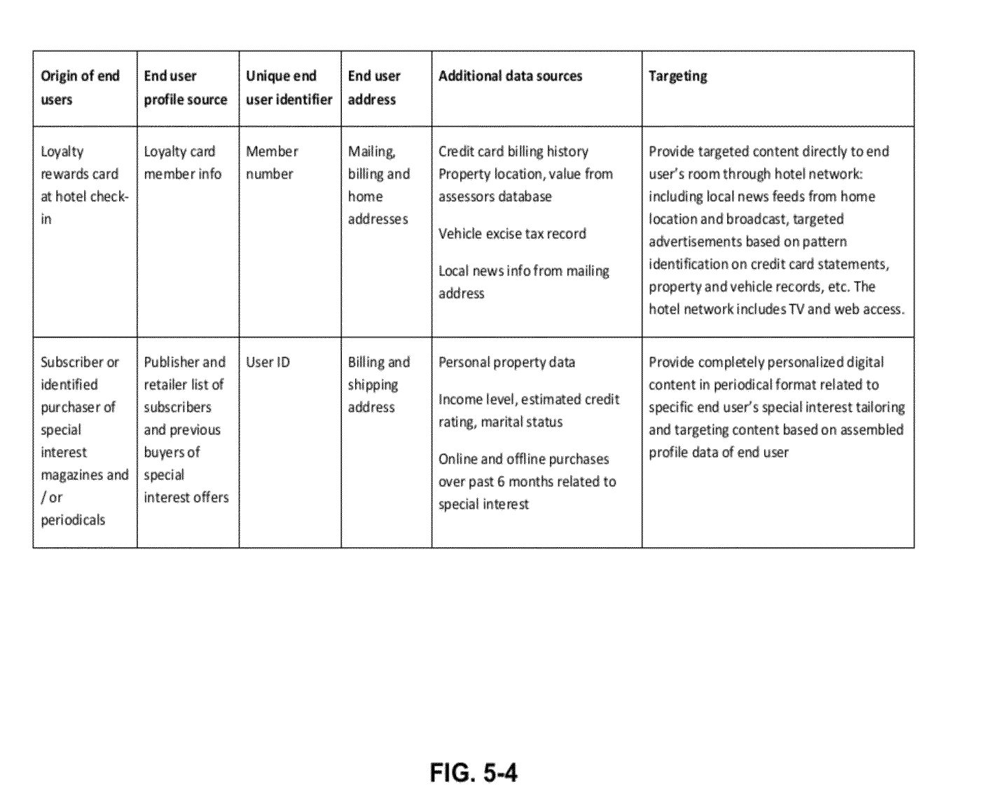

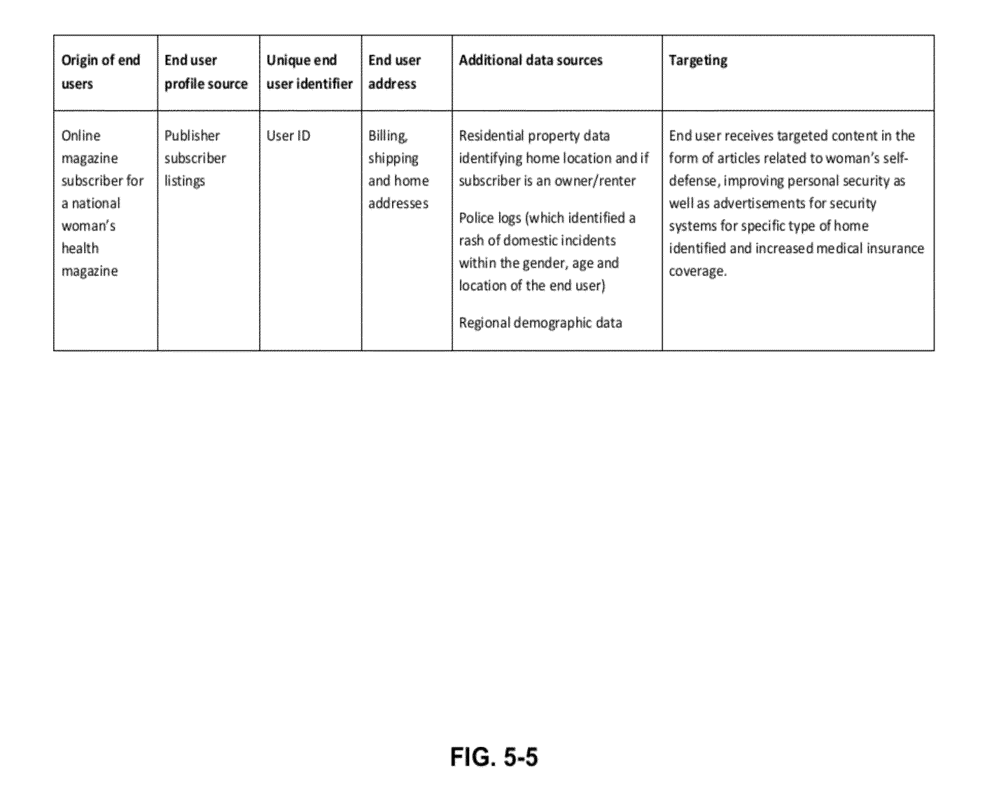

FIG. 5-1, FIG. 5-2, FIG. 5-3, FIG. 5-4, and FIG. 5-5 show tables of examples of implementations for combinations of the assembly and analysis of end user data centered around an address for the purposes of ad targeting. The first column, Origin of end users, describes examples of the means by which an end user becomes part of the ad targeting process. These can include using a mobile device, utilizing a digital service within a checkout kiosk or perhaps buying or subscribing to a digital product such as a magazine or periodical. The second column, End user profile source, describes examples of the initial source providing the end user profile information. These can include a publisher's list of subscribers, an ecommerce website or other website providing profiles of their registered end users, a merchant's customer list of those end users participating in royalty or rewards programs, The third column, Unique end user identifier, describes examples of the unique identifier assigned to each end user as part of the end user profile provided in the second column. The fourth column, End user address, describes examples of a physical address or in some cases multiple addresses associated with each end user. These addresses can be mailing, billing, home, business or other physical address. The fifth column, Additional data sources, describes examples of data acquired from additional other end user data sources that can be mashed up and assembled with the physical address of the end user as well as with the profile information to enable specific content targeting. The sixth column, Targeting, describes examples of specifically targeted content that an end user may receive based on the mashup and analysis of the compiled end user profile mashup.

### Other Embodiments

As will be apparent to those skilled in the art, many aspects of the disclosure may be implemented in various differing fashion while still functioning with a targeted publishing system based on profile mashups.

Although this implementation is described with certain part of the processing done by the content targeting subsystem and other parts by the end user profile mashup subsystem, the targeted content placement subsystem, the targeted content management subsystem, and the general content management subsystem, alternative implementations of the system could be implemented where parts of the processing is performed by another subsystem than the subsystem mentioned in this implementation.

Another implementation could define an end user address as something else than a physical address, which can still be used to correlate data about the end user.

Another implementation could use end user addresses directly without normalizing them, and instead use search or lookup mechanisms related to each data source in order to compile the profile mashup.

Another implementation could normalize end user addresses into a format specific for each data source.

Another implementation could differentiate between end user addresses which identifies the end user with varying degrees of specificity (e.g. as an individual, an address, an apartment complex, or an office building), and apply the data from the other end user data sources differently to the profile mashup based on the specificity of either the identification of the end user or the address in the data source.

Another implementation can include refinements, priorities, or selections of end user addresses based on address origin, and other matching of data.

Another implementation could combine profile mashup information with current physical location (from geo-location information) to further refine relevant content, including using the address of the current physical location as another end user address.

Another implementation could combine this targeting method with behavioral targeting, by adding, tracking, or referencing behavioral data in the collected profile which is turn is used in the profile mashup.

Another implementation could combine this targeting method with contextual targeting, by additionally using contextual data when creating targeted content locations and targeted content placements.

Another implementation could store profile mashups as a combination of structured and unstructured data from the other end user data sources, which could be fully or partially created on-the-fly, when a profile mashup for an individual end user is requested.

Another implementation could create the profile mashup criteria fully or partially created on-the-fly, when a profile mashup for an individual end user is requested.

Another implementation could manage the targeted content within the same database as the general content while only managing the targeted content placements separately.

Another implementation could store the targeted content locations separately from the general content.

Another implementation could have general content which only contains targeted content locations and as a result publish only targeted content to end users.

Another implementation could identify targeted content locations based on how general content management systems stores content and identifies sections of the content.

Another implementation could extend the general content management subsystem to add meta information and targeting information to the general content in order to help the content targeting subsystem identify or replace the relevant content.

Another implementation could implement pre-compute the values of profile mashup examination queries used in targeted content placements and save them in profile mashup criteria in order to have the relevant list of targeted content placements readily available when assembling content for a specific end user.

Another implementation could extend the targeted content placements and the targeting mechanism to additionally include traditional methods used in creating targeted advertisements and personalized content.

Another implementation could determine the priorities of potential targeted content placements based on additional information from the general content, targeted content, end user profile mashup, or a combination of the above.

Another implementation could split the tasks of the targeted content management user between managing personalized content and managing targeted advertisements.

Another implementation could look up multiple end users in a data source at a time instead of looking them up one by one.

Another implementation could use parallel processing techniques to process the ordered list of targeted content placements in parallel instead of processing them one by one.

Another implementation could run the general content management subsystem or the complete system in-house in an organization instead of over a network.

Another implementation could integrate into an existing publishing pipeline using an existing general content management subsystem and/or the existing mechanism for delivering the assembled content to the end user.

Another implementation could deliver the assembled content to an individual on a physical medium (magazine, news-paper, CD, DVD, Blu-ray disc, etc.).

Another implementation could create the assembled content to end users and deliver it them on a schedule or when the general content or targeted content is ready for publishing.

Another implementation could run multiple instances of the system in a multi-tenant configuration while segregating or partially sharing the end user profile mashups across these instances.

Another implementation could implement the examination of profile mashups using standard search engine techniques or data mining techniques or both.

Another implementation could add traditional on-line advertisement placement techniques to the strategies used in assembling content.

Another implementation could add customization of assembled content based on the end user device—including a dedicated reading device, a multi-media player (a MP3 player, a video player, etc.), a hand held device (a smart phone, an iPad, etc.), and a general purpose computer (a laptop, a desktop, etc.).

Another implementation could assemble the content dynamically on the fly when individual portions of the content are requested by the end user.

Another implementation could assemble the content on the end user device, where the general content, targeted content, and end user profile data could come from the same location or different locations.

Another implementation could implement the general content management system on the Internet and reference the targeted content through links (URLs, URIs, etc) in the general content.

Another implementation could automate the functions of the targeted content management user with an automated system utilizing business, artificial and other automated intelligence techniques to make determinations about targeted content.

Another implementation could bypass the need for the end user to make a request to the content targeting subsystem by pre-assembling the end user's selected targeted content based on the targeted content placements and store the pre-assembled content until the end user makes the request for download.

Another implementation could define target priority as a value determined by meta data analysis, A.I. and information from other end user data sources that ascribe a value to certain end users as it related to the targeted content and targeted content placements.

What is claimed is:

1. A system for publishing targeted content comprising:
a general content management subsystem for managing general content in a general content database;
a targeted content management subsystem for managing targeted content in a targeted content database;
an end user profile mashup subsystem for compiling profile mashups of identified end users by combining end user information from an end user profile database with data from other end user data sources based on one or more end user addresses;
a content targeting subsystem for creating assembled content to deliver to identified end users from the general content database and the targeted content database using information from profile mashups compiled by the end user profile mashup subsystem to select the targeted content.

2. The system of claim 1, wherein the assembled content is delivered to an end user device via a computer network.

3. The system of claim 2, wherein the assembled content is delivered as a document.

4. The system of claim 2, wherein the assembled content is delivered through an app.

5. The system of claim 2, wherein the assembled content is delivered through a web-site.

6. The system of claim 1, wherein the assembled content is delivered to an end user in a physical form.

7. The system of claim 1, wherein the end user address comprises a physical address.

8. The system of claim 7, wherein the end user address comprises a billing address.

9. The system of claim 7, wherein the end user address comprises a shipping address.

10. The system of claim 1, wherein the identified end users are identified using electronic identifiers.

11. The system of claim 10, wherein the identified end users are identified using subscriber IDs.

12. The system of claim 10, wherein the identified end users are identified using email addresses.

13. The system of claim 10, wherein the identified end users are identified using website logins.

14. The system of claim 1, wherein the targeted content comprises an advertisement.

15. The system of claim 1, further comprising:
a targeted content placement subsystem for managing targeted content placements, which identify locations within the general content where targeted content is to be placed, in a targeted content placement database, and making the targeted content placements available to the content targeting subsystem for use when assembling content.

16. The system of claim 1, wherein the assembled content comprises a publication.

17. The system of claim 16, wherein the assembled content comprises an electronic publication.

18. The system of claim 16, wherein the assembled content comprises a printed publication.

19. The system of claim 1, wherein the end user profile mashup subsystem compiles the profile mashups of identified end users by combining end user information from an end user profile database with data from other end user data sources where one or more of the end user addresses approximately equals an address in the other end user data sources.

20. A system for publishing targeted content comprising:
a targeted content management subsystem for managing targeted content in a targeted content database;
an end user profile mashup subsystem for compiling profile mashups of identified end users by combining end user information from an end user profile database with data from other end user data sources based on one or more end user addresses; and
a content targeting subsystem for creating assembled content to deliver to identified end users from the targeted content database using information from profile mashups compiled by the end user profile mashup subsystem to select the targeted content.
